(19) United States
(12) Patent Application Publication
(10) Pub. No.: US 2011/0235489 A1
(43) Pub. Date: Sep. 29, 2011

(54) INFORMATION RECORDING/REPRODUCTION DEVICE AND IMAGE FORMING METHOD

(75) Inventors: Masaharu IMURA, Osaka (JP); Kazuhiro MURAKAMI, Kyoto (JP)

(73) Assignee: PANASONIC CORPORATION, Osaka (JP)

(21) Appl. No.: 13/155,740

(22) Filed: Jun. 8, 2011

Related U.S. Application Data
(63) Continuation of application No. PCT/JP2010/000510, filed on Jan. 28, 2010.

(30) Foreign Application Priority Data
Mar. 3, 2009 (JP) 2009-049772
Mar. 17, 2009 (JP) 2009-064384

(51) Int. Cl. G11B 7/125

(52) U.S. Cl. 369/53.27; G9B/7.099

(57) ABSTRACT

An image formation width calculation circuit and an image formation shift amount determination circuit are provided so that, before a visible image is formed, an effective image formation diameter of an image formation laser spot is measured, and based on the result, a shift amount of the laser spot is adjusted. An optical pickup which forms a plurality of laser spots on an optical disk is also provided. An image formation focus control laser power control circuit and an image formation laser power control circuit are also provided. A focus control laser spot is located ahead of the image formation laser spot.

### CROSS-REFERENCE TO RELATED APPLICATIONS

This is a continuation of PCT International Application PCT/JP2010/000510 filed on Jan. 28, 2010, which claims priority to Japanese Patent Application No. 2009-049772 filed on Mar. 3, 2009 and Japanese Patent Application No. 2009-064384 filed on Mar. 17, 2009. The disclosures of these applications including the specifications, the drawings, and the claims are hereby incorporated by reference in their entirety.

### BACKGROUND

The present disclosure relates to techniques of forming visible images on information recording media, such as optical disks etc.

There are some known conventional information recording media (e.g., a compact disc-recordable (CD-R), a compact disc-rewritable (CD-RW), a digital versatile disc-recordable (DVD-R), a digital versatile disc-rewritable (DVD-RW), etc.) which have a feature that visible images can be formed on the label side opposite to the information recording side. There are also known optical disk recording devices which record, on the label side of the information recording medium, titles for identifying information recorded on the information recording side, music information of music data, etc., as visible images (see Japanese Patent Publication No. 2003-203348).

FIG. 22 is a block diagram showing a conventional optical disk recording device (see Japanese Patent Publication No. 2004-5848). This device has not only a typical information recording function of recording information by irradiating the recording side of an optical disk with laser light, but also an additional image forming function of forming an image on a color changing layer which changes color due to heat or light, by irradiating the color changing layer with laser light. The color of the color changing layer is changed by heat or light when the layer is irradiated with laser light having a predetermined intensity or more. Therefore, an intended image is formed on the optical disk by setting an optical pickup to face a surface (label side) of a protective layer on the back of the recording layer which is normally used to record information, and irradiating the optical disk with laser light having an intensity sufficient to change the color of the color changing layer.

Initially, information about an image to be formed on an optical disk 1801, i.e., image data, is accumulated from a host computer via an interface circuit 1812 into a frame memory 1814. The image data is a set of gray level data which defines the density of dots to be written on the optical disk 1801. Each dot is located at an intersection of a concentric circle and a radial line from the center of the optical disk 1801.

A system controller 1815 performs a determination process and a read process on the image data accumulated in the frame memory 1814, and thereafter, supplies the resultant image data to a data converter 1813. The data converter 1813 converts the image data into data for image formation, and outputs the image formation data to a laser driver 1816. On the other hand, a laser power control circuit 1817 outputs, to the laser driver 1816, a drive control signal for outputting laser power in an amount specified by the system controller 1815. The laser driver 1816 supplies a laser drive signal to a laser diode 1803 based on the image formation data from the data converter 1813 and the drive control signal from the laser power control circuit 1817, to drive the laser diode 1803 to emit laser light. The emitted laser light is received by a front monitor 1804. A voltage corresponding to the amount of the light is supplied to the laser power control circuit 1817. The laser power control circuit 1817 performs a feedback control so that the intensity of the laser beam becomes equal to a target value supplied by the system controller 1815. With such a structure, the optical disk 1801 is irradiated with laser light corresponding to image data from the host computer.

On the other hand, a servo circuit 1809 operates an objective lens (not shown) in a direction of the optical axis and a radial direction of the optical disk based on a focusing signal and a tracking signal supplied to an actuator 1806. The level of reflected light detected by a reflected light receiver 1805 is transferred via an RF amplifier 1811 to the servo circuit 1809. Note that, during image formation, a tracking signal is generated based on an instruction from the system controller 1815 without performing a tracking control.

A stepping motor 1807 rotates to move the optical pickup 1802 in the radial direction of the optical disk 1801. A motor driver 1808 supplies, to the stepping motor 1807, a drive signal for moving the optical pickup 1802 in a direction and an amount specified by the system controller 1815.

A spindle motor 1810 rotates the optical disk 1801 on which an image is to be formed. A rotation detector 1818 outputs a signal FG having a frequency corresponding to the rotational speed of the spindle. The servo circuit 1809 performs a feedback control so that the rotational speed of the spindle motor 1810 detected based on the signal FG becomes equal to an angular velocity specified by the system controller 1815. A PLL and frequency divider circuit 1819 generates a reference signal synchronous with the signal FG and supplies the reference signal to the system controller 1815. The timing of laser emission and the rotation of the optical disk 1801 are synchronized with each other based on the reference signal.

With the above structure, an image is formed on the optical disk 1801 by irradiating the optical disk 1801 with laser light corresponding to image data while performing main scanning by rotation of the optical disk 1801 and sub-scanning by movement of the optical pickup 1802 from the inner periphery to the outer periphery, where the label side faces the optical pickup 1802.

Next, a feedforward tracking control which is a feature of the above conventional technique will be described. In general, the spot diameter of laser is about 1 which is as small as 1/10 of the minimum radial movement amount (D: about 10 μm, a radial image resolution) of the optical pickup 1802. Therefore, a portion of one dot which actually changes color is a linear portion which is irradiated with laser light and is only about 1/10 of the entirety. In other words, the remaining 9/10 of the entire dot is not irradiated with laser light and therefore, the color is not changed, resulting in a reduction in the contrast ratio of the formed image, which leads to a degradation in the visibility of the image.

FIG. 23 is a diagram showing paths of laser light during image formation as viewed from the label side of the optical disk 1801, where solid lines (1)-(8) indicate the paths of laser light each corresponding to one revolution. The horizontal axis indicates the circumferential direction of the disk, and the vertical axis indicates the radial direction of the disk. FIG. 23 shows eight revolutions during image formation. As shown by the paths (1)-(8) of FIG. 23, tracking signals having the same frequency and amplitude and different phases varying from revolution to revolution are applied so that the irradiation paths of laser light vary from revolution to revolution during image formation. As a result, dots having a width larger than the actual laser spot diameter are formed. Note that the number of revolutions (the number of overlaps) may be held as a fixed value by the system controller 1815, or alternatively, may be specified by the host computer via the interface circuit 1812 as shown in FIG. 22.

Conventionally, when a high-definition image is formed, the laser spot diameter may not be constant in each optical disk recording device, and therefore, the image formation width (color changing width) may not be stable, so that inconsistencies may occur in the formed image in the radial direction. Also, variations in the image formation width may occur due to bleeding in the image formation region caused by laser power, disadvantageously resulting in a degradation in image quality.

When a focus control is performed using a laser spot for image formation, a focus error signal may be disturbed by emission of light having an image formation pattern during image formation, so that the focus control may become unstable. As a result, the laser spot diameter may fluctuate, so that the image formation width may become unstable, and therefore, the image quality may be degraded.

In conventional structures, when an image is formed on the color changing layer of an optical disk, the number of revolutions for image formation is increased while vibrating the tracking drive to form dots having a width greater than the laser spot diameter, thereby ensuring the contrast ratio of an formed image. However, when the number of revolutions specified by the host computer is excessively large, irradiation paths of laser light become dense. As a result, color changes significantly in the color changing layer in an image formation portion where paths are adjacent to each other, to have a higher gray level (darker) than that which is expected, so that the entire contrast ratio is degraded.

FIG. 24 shows the relationship between laser powers for image formation and levels of light reflected from an optical disk, and the relationship between laser powers for image formation and contrasts of formed images, in the optical disk recording device of FIG. 22. As shown in FIG. 24, in a case (a) where the image formation laser power is low, the degree of a color change in the color changing layer is small, and the level of reflected light in a portion where an image has been formed is low. Therefore, the entire formed image has only a low gray level (a)′, resulting in a degradation in the contrast ratio. When the image formation laser power is increased, the amount of the color change in the color changing layer increases and therefore the level of reflected light also increases, so that the highest contrast (b)′ of a formed image is obtained at a point (b) where the level of reflected light is highest. Thereafter, even if the image formation laser power is further increased, the degree of the color change in the color changing layer does not increase, so that the level of reflected light no longer changes, i.e., is saturated (c). On the other hand, if the image formation laser power is increased, the color of the color changing layer in surrounding regions is changed, so that the entire formed image has only a high gray level (c)′, and therefore, the contrast ratio is degraded. Thus, there exists an optimum laser power Po for image formation where the contrast ratio is highest.

FIG. 25 shows that the relationship between the image formation laser power and the level of light reflected from an optical disk varies depending on the number of revolutions (the number of overlaps). In general, as the number of overlaps increases, a higher-definition image may be obtained, but a longer recording time may be required. Conversely, as the number of overlaps decreases, a shorter recording time may be required, but a lower-definition image may be obtained. According to FIG. 25, when the number of overlaps is large (A), the distance between each point which is irradiated with laser light is narrow, and therefore, the irradiation with the image formation laser power has a large influence (heat and light) on surrounding regions. In this case, an optimum laser power for image formation (Pa) is lower than an optimum laser power for image formation Pb which is obtained when the number of overlaps is at an intermediate level (B). Conversely, when the number of overlaps is small (C), the distance between each point which is irradiated with laser light is wide, and therefore, the irradiation with the image formation laser power has a small influence on surrounding regions, so that a high optimum laser power for image formation (Pc) is obtained.

Thus, the optimum laser power for image formation has a characteristic depending on the number of overlaps. However, in the conventional art, recording is performed using a fixed laser power for image formation irrespective of the number of overlaps, and therefore, disadvantageously, images having a poor contrast ratio (excessively light or dark) may be formed in some number of overlaps.

### SUMMARY

The present disclosure describes implementations of a technique of reducing or preventing a degradation in the image quality of an image which is formed on the label side of an optical disk by an information recording/reproduction device.

The present disclosure also describes implementations of an information recording/reproduction device and an image forming method which can reduce or prevent a degradation in the contrast ratio of a formed image.

According to a first aspect of the present disclosure, in order to measure an image formation width before an image is formed on a label side using laser light, test write is performed to write a single line using a laser spot of laser light having a laser power for image formation condensed on the label side. Thereafter, a laser spot of laser light having a laser power which does not change the color of the label side is moved across a color changed region obtained by the test write while being vibrated in a radial direction, to detect the color changed region, and obtain an image formation width corresponding to the single line formed by the test write. When a visible image is formed, a shift amount of a laser spot for image formation is determined from the image formation width corresponding to the single line, whereby the laser spot shift amount can be suited to an actual image formation width which depends on variations in the laser spot diameter or the degree of bleeding of a color change caused by the laser power. Therefore, variations among devices can be reduced, resulting in a high-definition visible image.

According to a second aspect of the present disclosure, a plurality of laser beams are used, a focus control is performed using a laser beam preceding in an image formation direction, and image formation is performed using the other laser beam or beams, whereby an image formation pattern of light emitted during image formation does not disturb a focus error signal. Also, the difference in the amount of reflected light between the presence and absence of a color change after image formation does not disturb a focus error signal. Therefore, the focus control is stabilized, the fluctuation of the laser spot diameter is reduced, and the image formation width is constant, resulting in a high-definition visible image.

According to a third aspect of the present disclosure, a plurality of laser beams are used, a focus control is performed using a laser beam preceding in an image formation direction, and image formation is performed using the other laser beam or beams. In addition, in order to measure an image formation width before an image is formed on a label side using laser light, test write is performed to write a single line using a laser spot of laser light having a laser power for image formation condensed on the label side. Thereafter, a laser spot of laser light having a laser power which does not change the color of the label side is moved across a color changed region obtained by the test write while being vibrated in a radial direction, to detect the color changed region, and obtain an image formation width corresponding to the single line formed by the test write. When a visible image is formed, a shift amount of a laser spot for image formation is determined from the image formation width corresponding to the single line, whereby the laser spot shift amount can be suited to an actual image formation width which depends on variations in the laser spot diameter or the degree of bleeding of a color change caused by the laser power. Therefore, variations among devices can be reduced and a stable focus control can be obtained, whereby the fluctuation of the laser spot diameter can be reduced, resulting in a high-definition visible image.

According to a fourth aspect of the present disclosure, a laser power for image formation is optimized, depending on a specified number of overlaps before an image is formed.

According to the first to third aspects of the present disclosure, the information recording/reproduction device can form a high-definition visible image on a label side. Also, because a laser spot preceding a laser spot for image formation is used to perform a focus control during image formation, the focus control is stabilized, i.e., the focus control does not fail.

According to the fourth aspect of the present disclosure, a laser power for image formation is optimized, depending on a specified number of overlaps before an image is formed, whereby a degradation in the contrast ratio of an image which is formed, depending on the number of overlaps, can be reduced or prevented.

### BRIEF DESCRIPTION OF THE DRAWINGS

FIG. 1 is a block diagram showing a configuration of an optical disk recording device according to a first embodiment of the present disclosure.

FIG. 2 is a diagram for describing operation of forming a visible image performed by the optical disk recording device of the first embodiment of the present disclosure.

FIG. 3 is a diagram for describing paths of a laser spot when an image formation width is measured by the optical disk recording device of the first embodiment of the present disclosure.

FIG. 4 is a diagram for describing a method for measuring an image formation width performed by the optical disk recording device of the first embodiment of the present disclosure.

FIG. 5 is a block diagram showing a configuration of an optical disk recording device according to a second embodiment of the present disclosure.

FIG. 6 is a block diagram showing a configuration of an optical pickup in the optical disk recording device of the second embodiment of the present disclosure.

FIG. 7 is a diagram for describing positions of laser spots in the optical disk recording device of the second embodiment of the present disclosure.

FIG. 8 is a diagram for describing shapes of laser spots in the optical disk recording device of the second embodiment of the present disclosure.

FIG. 9 is a block diagram showing a configuration of an optical disk recording device according to a third embodiment of the present disclosure.

FIG. 10 is a block diagram showing a configuration of an optical disk recording device according to a fourth embodiment of the present disclosure.

FIG. 11 is a flowchart of an image forming method for use in the optical disk recording device of the fourth embodiment of the present disclosure.

FIG. 12 is a flowchart showing details of a test image formation step in the optical disk recording device of the fourth embodiment of the present disclosure.

FIG. 13 is a diagram for describing stepwise image formation laser powers in the optical disk recording device of the fourth embodiment of the present disclosure.

FIG. 14 is a flowchart showing details of a test image formed region reproduction step in the optical disk recording device of the fourth embodiment of the present disclosure.

FIG. 15 is a flowchart showing details of an optimum image formation laser power determination step in the optical disk recording device of the fourth embodiment of the present disclosure.

FIG. 16 is a diagram showing the relationship between image formation laser powers and levels of light reflected from an optical disk, which is used to determine an optimum image formation laser power in the optical disk recording device of the fourth embodiment of the present disclosure.

FIG. 17 is a flowchart showing details of a test image formation step in an optical disk recording device according to a fifth embodiment of the present disclosure.

FIG. 18 is a diagram for describing two levels of image formation laser power in the optical disk recording device of the fifth embodiment of the present disclosure.

FIG. 19 is a flowchart showing details of a test image formed region reproduction step in the optical disk recording device of the fifth embodiment of the present disclosure.

FIG. 20 is a flowchart showing details of an optimum image formation laser power determination step in the optical disk recording device of the fifth embodiment of the present disclosure.

FIG. 21 is a diagram showing the relationship between image formation laser powers and levels of light reflected from an optical disk, which is used to determine an optimum image formation laser power in the optical disk recording device of the fifth embodiment of the present disclosure.

FIG. 22 is a block diagram showing a conventional optical disk recording device.

FIG. 23 is a diagram showing paths of laser light when an image is formed, as viewed from the label side of an optical disk in the optical disk recording device of FIG. 22.

FIG. 24 is a diagram showing the relationship between laser powers for image formation and levels of light reflected from an optical disk, and the relationship between laser powers for image formation and contrasts of formed images, in the optical disk recording device of FIG. 22.

FIG. 25 is a diagram showing that the relationship between the image formation laser power and the level of light reflected from an optical disk varies depending on the number of overlaps, in the optical disk recording device of FIG. 22.

### DETAILED DESCRIPTION

Embodiments of the present disclosure will be described hereinafter with reference to the accompanying drawings.

### First Embodiment

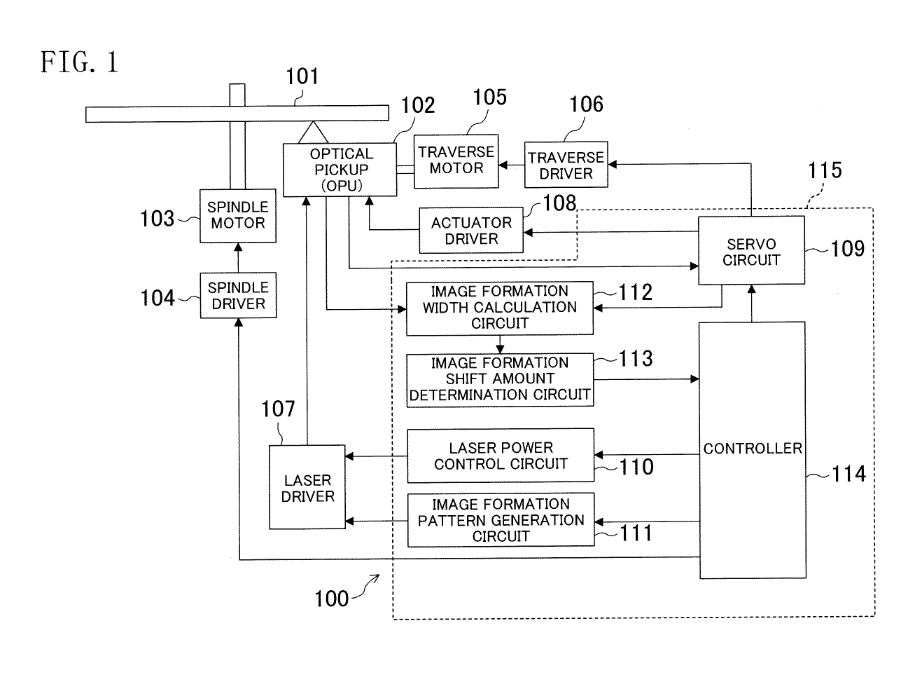

As shown in FIG. 1, an optical disk recording device 100 which is an information recording/reproduction device according to a first embodiment of the present disclosure includes: an optical disk 101 having, on the label side, an image formation surface which changes color due to heat or light; an optical pickup unit (OPU) 102; a spindle motor 103 which rotates the optical disk 101; a spindle driver 104 which drives the spindle motor 103; a traverse motor 105 which moves the OPU 102 in a radial direction of the optical disk 101; a traverse driver 106 which drives the traverse motor 105; a laser driver 107 which drives a laser diode (LD) (not shown) in the OPU 102; an actuator driver 108 which drives an objective lens (not shown) in the OPU 102; a servo circuit 109 which is a movement controller which controls the objective lens to a desired position based on a servo error signal from the OPU 102, and performs a traverse control to move the OPU 102 to a desired position in the radial direction; a laser power control circuit 110 which is a laser emission controller which controls the intensity of laser light so that the color of the label side is changed when an image is formed, and the color of the label side is not changed when an image formation width is obtained; an image formation pattern generation circuit 111 which is an image formation pattern generator which supplies an image formation pattern to the laser driver 107 during image formation; an image formation width calculation circuit 112 which is an image formation width calculator which calculates an image formation width based on a signal from the OPU 102; an image formation shift amount determination circuit 113 which is an image formation shift amount determiner which determines a shift amount of a laser spot which is used for image formation, based on the result of the image formation width calculation circuit 112; and a controller 114 which controls the entire operation of the optical disk recording device 100.

The servo circuit 109, the laser power control circuit 110, the image formation pattern generation circuit 111, the image formation width calculation circuit 112, the image formation shift amount determination circuit 113, and the controller 114 are implemented by an integrated circuit 115.

Operation of forming a visible image according to the present disclosure will be described hereinafter with reference to FIGS. 1-4.

When an image is formed, test write is initially performed using, for example, an outermost peripheral region of the label side where image formation is allowed, to calculate the width of a single line (image formation width) which is used when an image is formed.

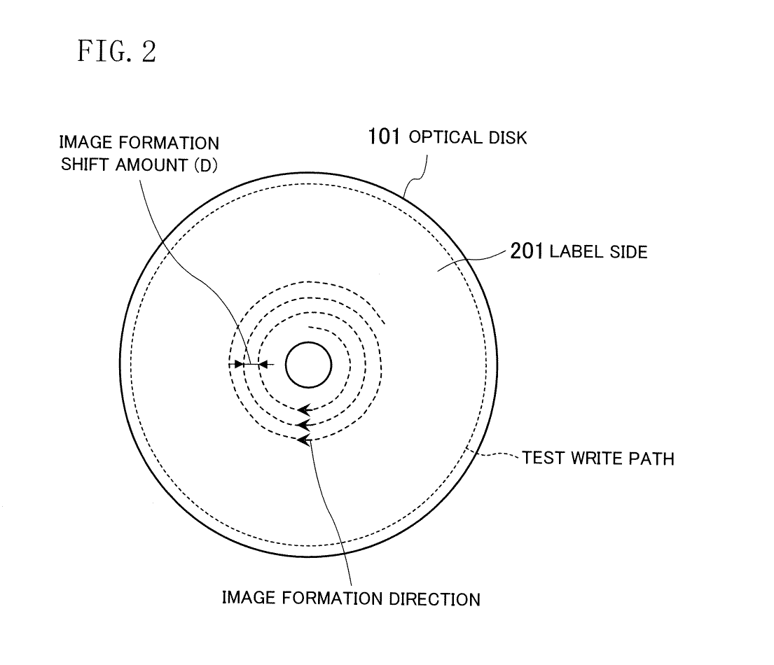

As shown in FIG. 2, the optical disk 101 has a label side 201 which is an image formation surface which is opposite to the information recording side and changes color due to heat or light. When a visible image is formed, an image formation pattern is written in a spiral manner from an inner periphery of the label side 201.

When an image is formed, the servo circuit 109 gradually moves the laser spot for image formation toward the outer circumference of the optical disk 101 by a shift amount per revolution (image formation shift amount (D)). The laser power control circuit 110 sets a laser power for image formation. The image formation pattern generation circuit 111 generates an image formation pattern required for image formation based on image formation data from the controller 114, and transfers the image formation pattern to the laser driver 107, which performs image formation.

The servo circuit 109 controls the actuator driver 108 and the traverse motor 105 to adjust the image formation shift amount (D) of the laser spot.

A required image formation shift amount (D) is measured before the above image formation as follows. Initially, the servo circuit 109 uses the traverse motor 105 to move the OPU 102 to an outermost peripheral portion of the label side 201. Next, the laser power control circuit 110 controls the laser power to a level which is used for image formation, and performs test write to write a single line.

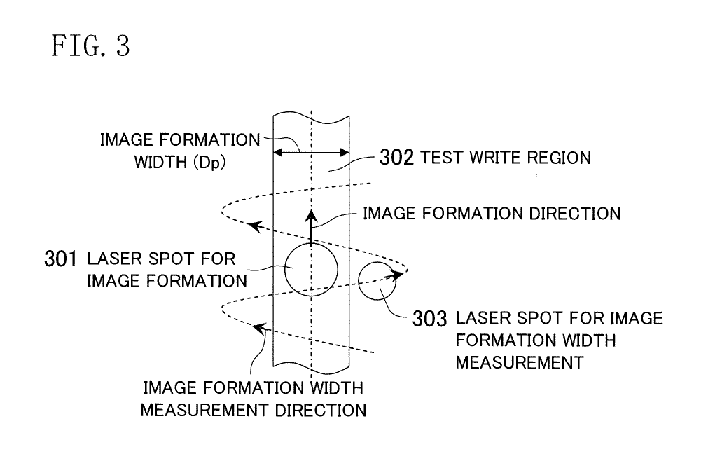

FIG. 3 shows a path of the laser spot when the image formation width is calculated. As shown in FIG. 3, a laser spot 301 for image formation which is a laser spot controlled to a laser power which is used for image formation is used to write a single line (test write). By the test write, a test write region 302 which is a color changed region corresponding to a single line is formed on the label side 201. The width of the color changed region in this case (hereinafter referred to as an image formation width (Dp)) varies among devices or optical disks because of conditions under which the color is changed, such as the laser power during image formation, changes over time in the color change sensitivity of the label side, etc.

The image formation width (Dp) is measured as follows. The laser power control circuit 110 sets the laser light to a laser power which does not change the color. The servo circuit 109 vibrates the objective lens in the radial direction using the actuator driver 108, thereby vibrating a laser spot 303 for measurement of the image formation width which is a laser spot which is set to a laser power which does not change the color so that the laser spot 303 moves across the test write region 302 in the radial direction.

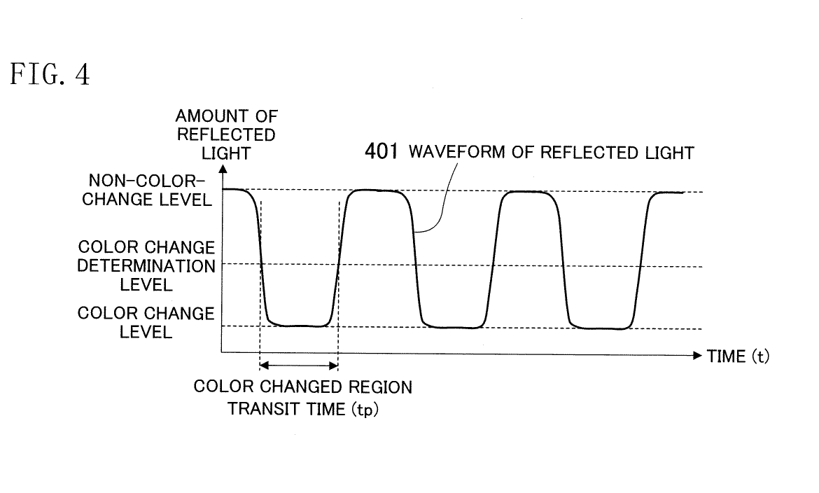

FIG. 4 shows the waveform of light reflected from the laser spot 303 for measurement of the image formation width. In FIG. 4, the waveform 401 of the reflected light shows that the amount of the reflected light is small when the laser spot 303 for measurement of the image formation width is moving in the test write region 302, and is large when the laser spot 303 is moving in a region whose color has not been changed.

The color changed region is detected as follows. Based on a reflected light signal from the OPU 102, the image formation width calculation circuit 112 measures a time (tp) which it takes to move across the color changed region, where a color change determination level is set to be an intermediate level between a reflected light amount level (color change level) of the color changed region and a reflected light amount level (non-color-change level) of the color unchanged region. The image formation width calculation circuit 112 also obtains information about the vibration frequency and vibration amplitude of the objective lens from the servo circuit 109 to calculate a speed (vp) at which the laser spot 303 for measurement of the image formation width moves across the test write region 302. The image formation width calculation circuit 112 can calculate the image formation width (Dp) based on the traverse speed (vp) and the color changed region transit time (tp).

Based on the image formation width (Dp) calculated by the image formation width calculation circuit 112, the image formation shift amount determination circuit 113 determines a shift amount (D) which is used for image formation. The servo circuit 109 controls the shift amount of the image formation laser spot 301 in the radial direction so that the laser spot 301 is moved by the shift amount (D) per revolution of the optical disk 101 when a visible image is formed. For example, of a plurality of image formation widths (Dp) calculated by the image formation width calculation circuit 112, a smallest image formation width is determined to be the image formation shift amount (D). As a result, an accurate image formation shift amount (D) can be obtained, whereby a high-quality visible image can be achieved.

Although, in the first embodiment, test write is performed in the outermost peripheral portion of the label side 201, test write may be performed in an innermost peripheral portion. The length of a line which is written in test write may be shortened as long as the image formation width can be measured. If a color changed region of the label side 201 in which a visible image is to be formed is previously known, test write may be performed in that region.

### Second Embodiment

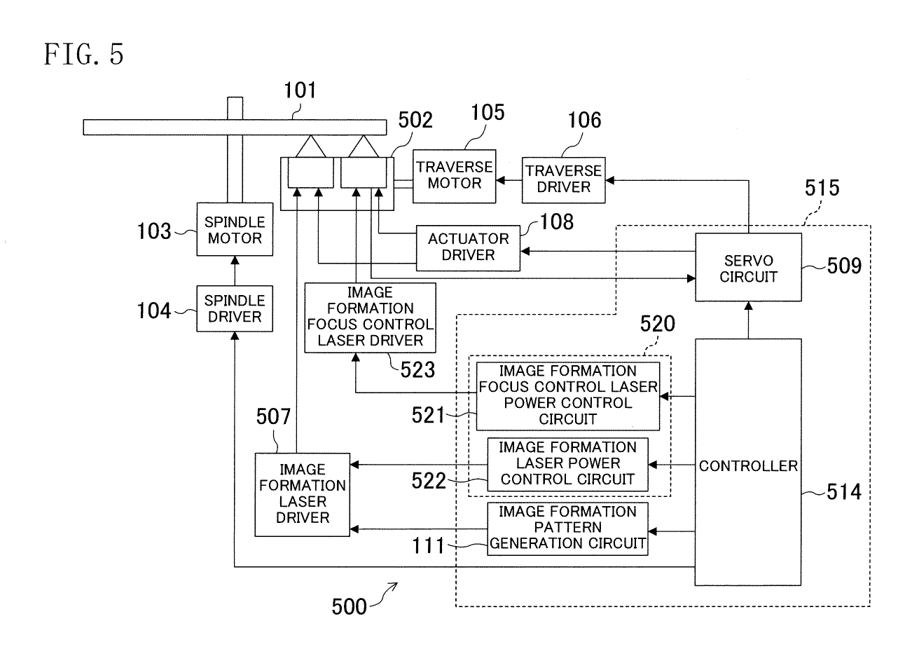

As shown in FIG. 5, an optical disk recording device 500 which is an information recording/reproduction device according to a second embodiment of the present disclosure includes: an optical disk 101 having, on the label side, an image formation surface which changes color due to heat or light; an OPU 502; a spindle motor 103 which rotates the optical disk 101; a spindle driver 104 which drives the spindle motor 103; a traverse motor 105 which moves the OPU 502 in a radial direction of the optical disk 101; a traverse driver 106 which drives the traverse motor 105; a laser driver 507 which drives an image formation LD (not shown) in the OPU 502; an image formation focus control laser driver 523 which drives an image formation focus control LD (not shown) for controlling a focus during image formation; an actuator driver 108 which drives an objective lens (not shown) in the OPU 502; a servo circuit 509 which serves as a focus controller which performs a focus control to move the objective lens to a desired position based on light reflected from a laser spot for a focus control during image formation in the OPU 502, and also serves as a movement controller which performs a traverse control to move the OPU 502 in the radial direction; an image formation laser power control circuit 522 which controls the intensity of laser light of the image formation LD so that the color of the label side is changed during image formation; an image formation focus control laser power control circuit 521 which controls the intensity of laser light of the image formation focus control LD for performing a focus control during image formation so that the color of the label side is not changed; an image formation pattern generation circuit 111 which is an image formation pattern generator which supplies an image formation pattern to the image formation laser driver 507 during image formation; and a controller 514 which controls the entire operation of the optical disk recording device 500.

The servo circuit 509, the image formation focus control laser power control circuit 521 and the image formation laser power control circuit 522, which constitute a laser emission controller 520, the image formation pattern generation circuit 111, and the controller 514 are implemented by an integrated circuit 515.

Operation of forming a visible image according to the present disclosure will be described hereinafter with reference to FIGS. 5-7.

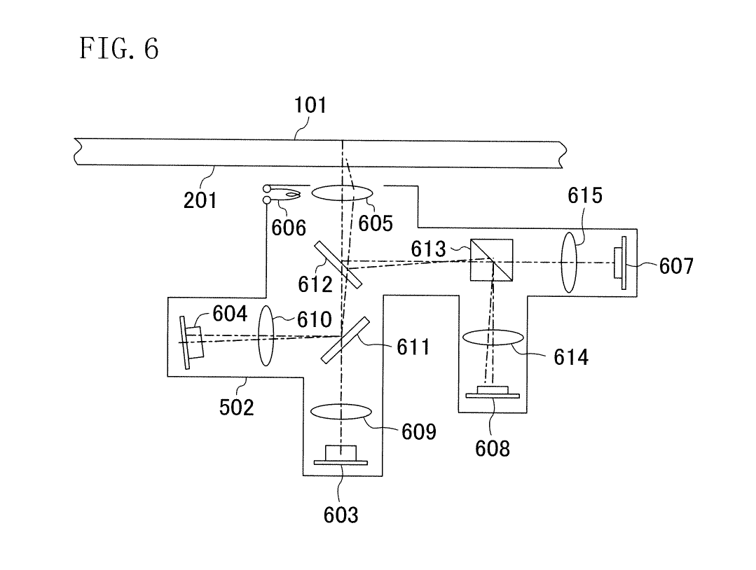

FIG. 6 shows a configuration of the OPU 502 of the second embodiment. As shown in FIG. 6, with respect to the optical disk 101 having an image formation surface (label side 201) which changes color due to heat or light, the OPU 502 includes: an image formation LD 603; an image formation focus control LD 604 which is used for a focus control during image formation; collimate lenses 609 and 610 which convert laser light beams emitted by the two LDs 603 and 604 into parallel laser beams; a half mirror 611 which directs the two laser beams toward the optical disk 101; an objective lens 605 which condenses the two laser beams as a laser spot onto the optical disk 101; a half mirror 612 which guides reflected light of the two laser spots toward photodetectors; a beam splitter 613 which guides two laser beams reflected from the half mirror 612 to the photodetectors; an image formation photodetector 607 which detects reflected light of image formation laser light; a focus control photodetector 608 which detects reflected light of laser light which is used for a focus control during image formation; condenser lenses 615 and 614 which are provided between the beam splitter 613 and the image formation photodetector 607 and between the beam splitter 613 and the focus control photodetector 608, respectively; and a focus control coil 606 which performs a focus control using the objective lens 605.

The image formation LD 603 may be, for example, a CD LD which is used to record and reproduce CD-Rs or CD-RWs, and the image formation focus control LD 604 may be, for example, a DVD LD which is used to record and reproduce DVD-Rs or DVD-RWs.

The image formation focus control LD 604 is provided so that a laser beam for a focus control during image formation is slightly offset from the optical axis of a laser beam for image formation, whereby the laser spot of the focus control laser beam is located ahead of the laser spot of the image formation laser beam in a direction in which image formation is performed.

FIG. 7 is an enlarged view showing the positional relationship between laser spots on the label side 201 during image formation. As shown in FIG. 7, an image formation focus control laser spot 705 is located ahead of an image formation laser spot 704.

When a visible image is formed, the image formation is started from an inner periphery of the label side 201. The optical disk 101 is rotated by the spindle motor 103, and the OPU 502 is moved, by the traverse motor 105, toward the outer circumference at a predetermined image formation shift rate (D). As a result, the image formation laser spot 704 is relatively moved in a spiral manner on the label side 201, whereby a visible image can be formed on the entire label side 201.

During the formation of a visible image, the image formation laser power control circuit 522 controls the laser power to a level which can change the color of the label side 201. The image formation pattern generation circuit 111 uses the image formation laser driver 507 to cause the image formation LD 603 to emit an image formation pattern of light. The objective lens 605 condenses the light onto the label side 201, whereby the image formation laser spot 704 is formed on the label side 201.

The image formation focus control laser power control circuit 521 controls the laser power to a level which does not change the color of the label side 201, and uses the image formation focus control laser driver 523 to cause the image formation focus control LD 604 to emit light. The laser light of the image formation focus control LD 604 is passed through the collimate lens 610, the half mirror 611, and the objective lens 605 and condensed onto the label side 201 to form the image formation focus control laser spot 705. The image formation focus control laser spot 705 is formed and focused on the label side 201 so as to perform a focus control, by the servo circuit 509 using the actuator driver 108 to cause a control current to flow through the focus control coil 606 and thereby controlling the objective lens 605.

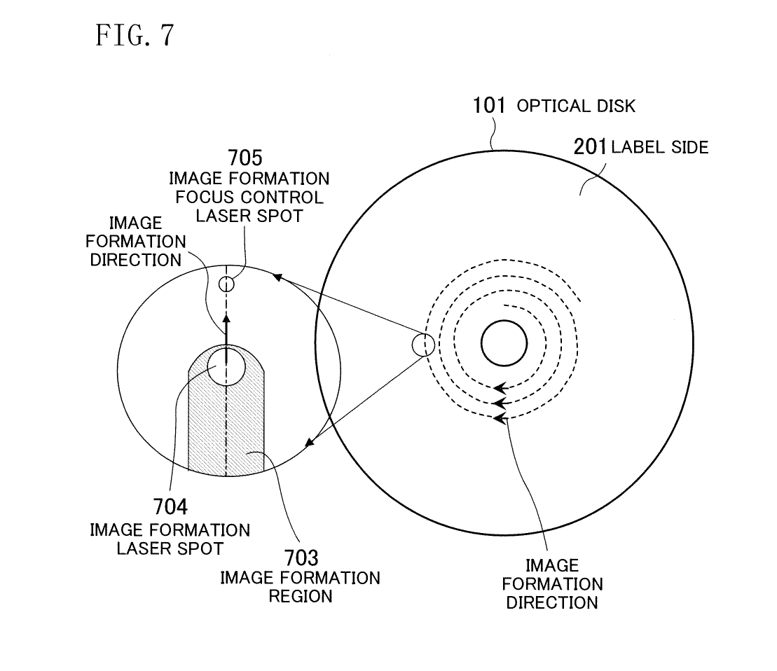

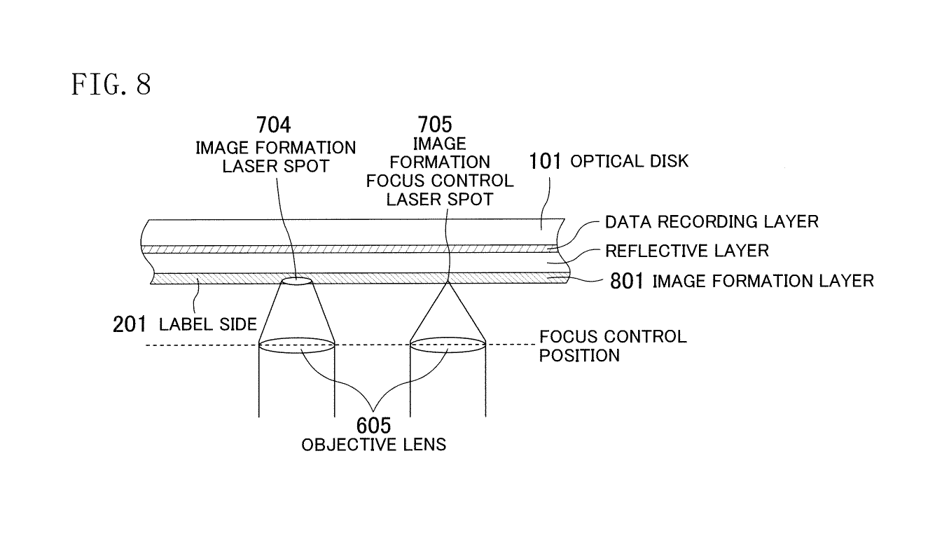

FIG. 8 shows shapes of laser spots on the label side 201 during image formation. Two separate objective lenses 605 are shown in FIG. 8 for the sake of description. As shown in FIG. 8, the image formation focus control laser spot 705 is focused on the label side 201 by a focus control. The image formation laser spot 704 is not focused on an image formation layer 801, and has a predetermined diameter. For example, if it is assumed that the image formation LD 603 is a CD LD which is used for CD-Rs and CD-RWs, and the image formation focus control LD 604 is a DVD LD which is used for DVD-Rs and DVD-RWs, the laser spot diameters inevitably have such a relationship in magnitude because of the design of the OPU 502. As the spot diameter of the image formation laser spot 704 increases, the image formation width increases. The larger image formation width may advantageously lead to a reduction in time which it takes to form a visible image, for example.

The image formation focus control laser spot 705 is not located in an image formation region 703 where an image is formed using the image formation laser spot 704. Therefore, the image formation focus control laser spot 705 is not affected by external disturbances, such as an image formation pattern of light emitted during image formation and fluctuations in reflectance due to a color change after image formation, and therefore, a stable focus control can be achieved. The stable focus control keeps the image formation laser spot diameter constant, so that the image formation width is also kept constant, whereby a high-quality visible image can be formed.

Although, in the second embodiment, the image formation focus control laser spot 705 is located ahead of the image formation laser spot 704, the image formation focus control laser spot 705 may be located in other regions other than the image formation laser spot 704 and the image formation region 703, e.g., may be located closer to the outer circumference than the image formation laser spot 704 is, etc.

### Third Embodiment

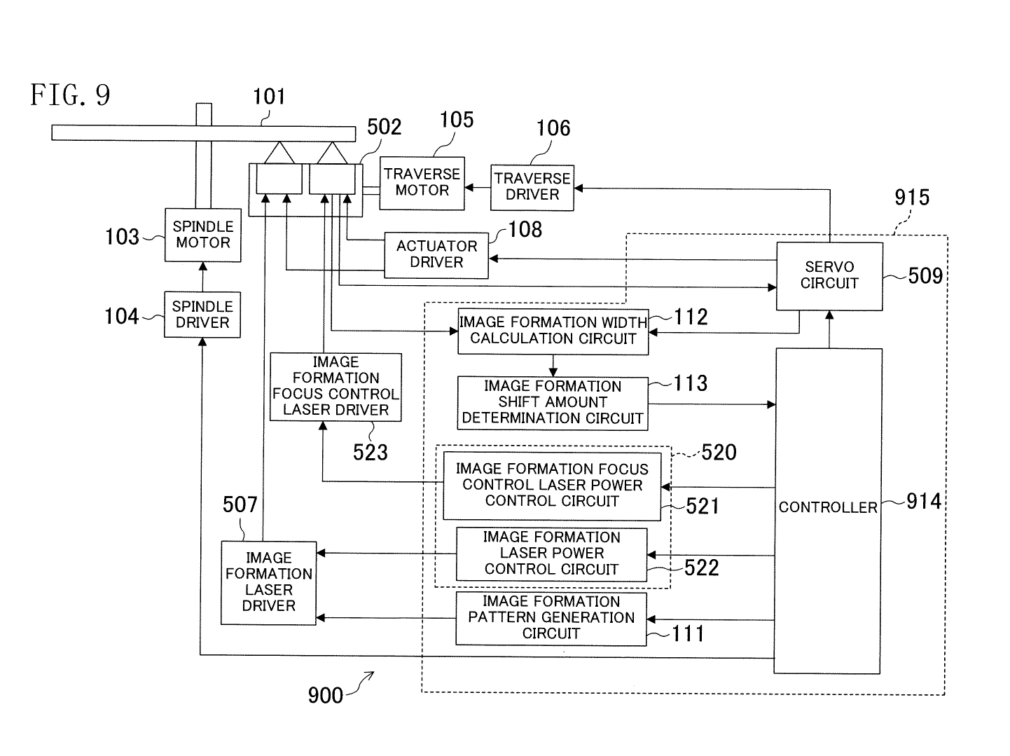

As shown in FIG. 9, an optical disk recording device 900 which is an information recording/reproduction device according to a third embodiment of the present disclosure includes: an optical disk 101 having, on the label side, an image formation surface which changes color due to heat or light; an OPU 502; a spindle motor 103 which rotates the optical disk 101; a spindle driver 104 which drives the spindle motor 103; a traverse motor 105 which moves the OPU 502 in a radial direction of the optical disk 101; a traverse driver 106 which drives the traverse motor 105; an image formation laser driver 507 which drives an image formation LD (not shown) in the OPU 502; an image formation focus control laser driver 523 which drives an image formation focus control LD (not shown) for performing a focus control during image formation; an actuator driver 108 which drives an objective lens (not shown) in the OPU 502; a servo circuit 509 which serves as a focus controller which performs a focus control to move the objective lens to a desired position based on light reflected from a laser spot for a focus control during image formation in the OPU 502, and also serves as a movement controller which performs a traverse control to move the OPU 502 to a desired position in the radial direction; an image formation laser power control circuit 522 which controls the intensity of laser light of the image formation LD so that the color of the label side is changed during image formation; an image formation focus control laser power control circuit 521 which controls the intensity of laser light of the image formation focus control LD for performing a focus control during image formation so that the color of the label side is not changed; an image formation pattern generation circuit 111 which is an image formation pattern generator which supplies an image formation pattern to the image formation laser driver 507 during image formation; an image formation width calculation circuit 112 which is an image formation width calculator which calculates an image formation width based on a signal from the OPU 502; an image formation shift amount determination circuit 113 which is an image formation shift amount determiner which determines a shift amount of the laser spot which is used for image formation, based on the result of the image formation width calculation circuit 112; and a controller 914 which controls the entire operation of the optical disk recording device 900.

The servo circuit 509, the image formation focus control laser power control circuit 521 and the image formation laser power control circuit 522, which constitute a laser emission controller 520, the image formation pattern generation circuit 111, the image formation width calculation circuit 112, the image formation shift amount determination circuit 113, and the controller 914 are implemented by an integrated circuit 915.

Operation of forming an image according to the present disclosure will be described with reference to FIG. 9. Note that the OPU 502 of the third embodiment has a configuration similar to that of the second embodiment. The positional relationship and shapes of laser spots on the label side during image formation in the third embodiment are also similar to those of the second embodiment.

A required image formation shift amount (D) is measured before a visible image is formed as follows. Initially, the servo circuit 509 uses the traverse motor 105 to move the OPU 502 to an outermost peripheral portion of the label side. Next, the image formation laser power control circuit 522 controls the laser power of a laser spot for image formation to a level for image formation, and performs a focus control using a laser spot for a focus control to perform test write to write a single line.

The width of a color change in this case (hereinafter referred to as an image formation width (Dp)) varies among devices or optical disks because of conditions under which the color is changed, such as the laser power during image formation, changes over time in the color change sensitivity of the label side, etc. In particular, the diameter of the image formation laser spot, on which a focus control is not performed, varies significantly among devices.

The image formation width (Dp) is measured as follows. The image formation focus control laser power control circuit 521 controls the laser power to a level which does not change the color. The servo circuit 509 uses the actuator driver 108 to vibrate the objective lens in the radial direction, thereby vibrating a laser spot for a focus control during image formation so that the laser spot moves across a test write region in the radial direction.

Based on the waveform of reflected light of the image formation focus control laser spot, the image formation width calculation circuit 112 measures a time (tp) which it takes to move across a color changed region, where a color change determination level is set to be an intermediate level between a reflected light amount level of the color changed region and a reflected light amount level of a color unchanged region. The image formation width calculation circuit 112 also obtains, from the servo circuit 509, information about the vibration frequency and vibration amplitude of the objective lens to calculate a speed (vp) at which the image formation focus control laser spot moves across a test write region. The image formation width calculation circuit 112 can calculate the image formation width (Dp) based on the traverse speed (vp) and the color changed region transit time (tp).

Based on the image formation width (Dp) calculated by the image formation width calculation circuit 112, the image formation shift amount determination circuit 113 determines a shift amount (D) which is used for image formation. The servo circuit 509 controls the shift amount of a laser spot for image formation in the radial direction so that the laser spot is moved by the shift amount (D) per revolution of the optical disk 101 when a visible image is formed. As a result, an accurate shift amount can be obtained even if the image formation width fluctuates when an image is formed using the image formation laser spot on which a focus control is not performed.

During the formation of a visible image, the image formation laser power control circuit 522 controls the laser power to a level which can change the color of the label side. The image formation pattern generation circuit 111 uses the image formation laser driver 507 to cause the image formation LD to emit an image formation pattern of light. The objective lens condenses the light onto the label side to form the image formation laser spot on the label side.

The image formation focus control laser power control circuit 521 controls the laser power to a level which does not change the color of the label side, and uses the image formation focus control laser driver 523 to cause the image formation focus control LD to emit light. The laser light of the image formation focus control LD is passed through a collimate lens, a half mirror, and the objective lens, and condensed onto the label side to form the image formation focus control laser spot. The image formation focus control laser spot is formed and focused on the label side so as to perform a focus control, by the servo circuit 509 using the actuator driver 108 to cause a control current to flow through a focus control coil and thereby controlling the objective lens.

The image formation focus control laser spot is not located in an image formation region where an image is formed using the image formation laser spot. Therefore, the image formation focus control laser spot is not affected by external disturbances, such as an image formation pattern of light emitted during image formation and variations in reflectance due to a color change after image formation, and therefore, a stable focus control can be achieved.

On the other hand, even if the image formation width of the image formation laser spot, on which a focus control is not performed, fluctuates, an accurate shift amount can be obtained. In addition, a stable focus control can be achieved, and therefore, the diameter of the image formation laser spot is kept constant, whereby a high-quality visible image can be formed.

### Fourth Embodiment

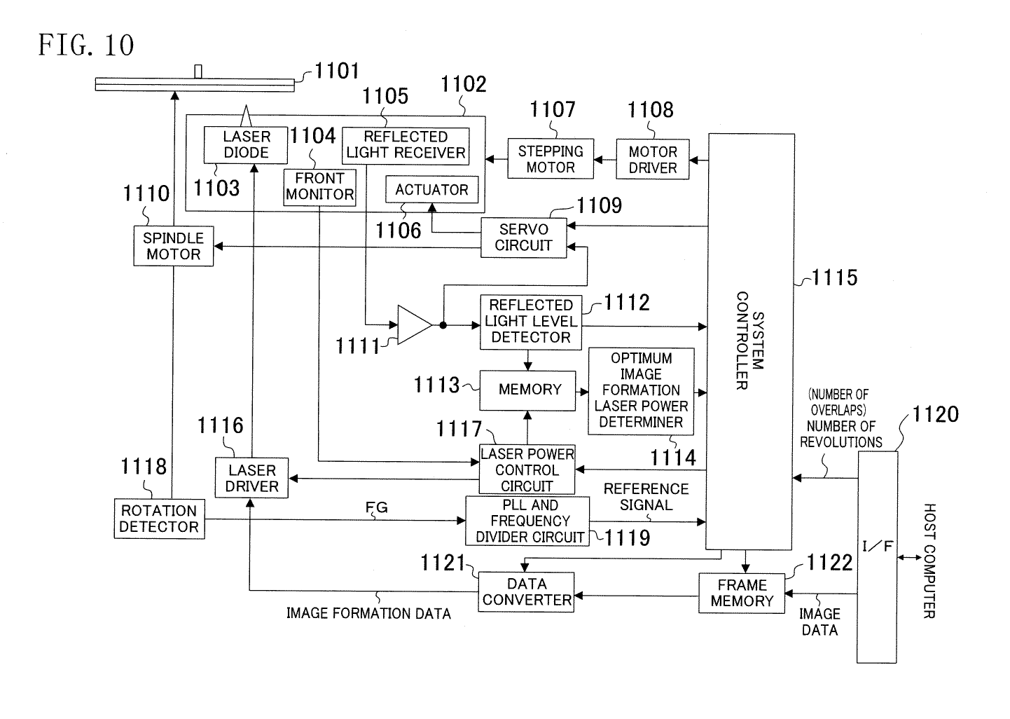

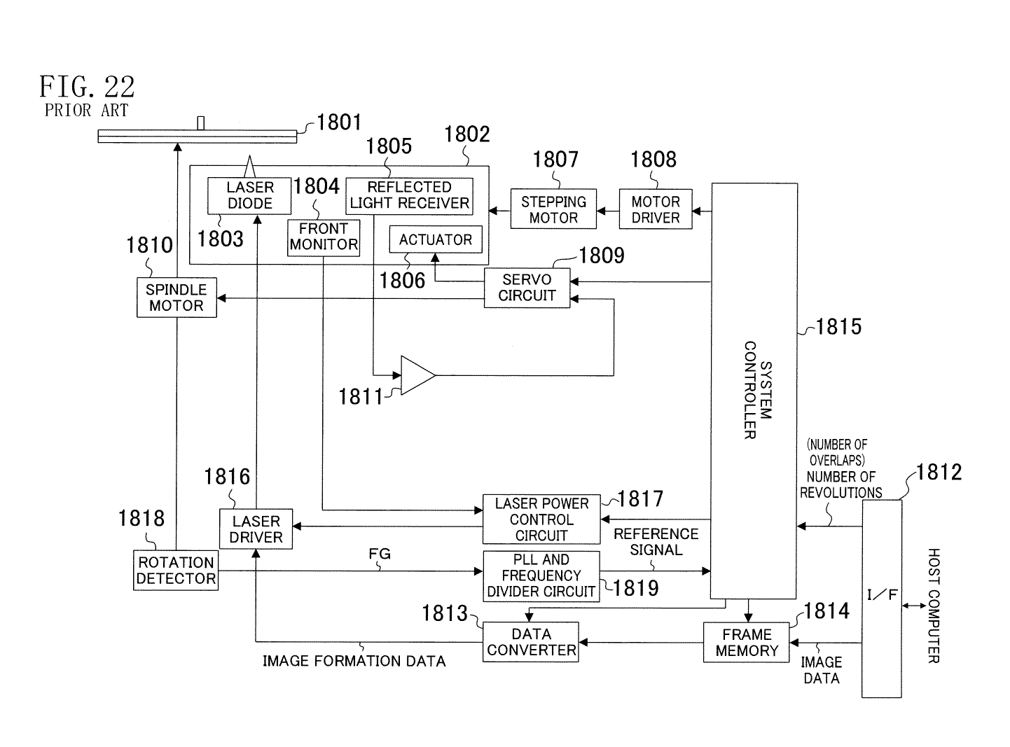

FIG. 10 is a block diagram showing an optical disk recording device which is an information recording/reproduction device according to a fourth embodiment of the present disclosure. In FIG. 10, an optical disk 1101, an optical pickup 1102, a laser diode 1103, a front monitor 1104, a reflected light receiver 1105, an actuator 1106, a stepping motor 1107, a motor driver 1108, a servo circuit 1109, a spindle motor 1110, an RF amplifier 1111, a system controller 1115, a laser driver 1116, a laser power control circuit 1117, a rotation detector 1118, a PLL and frequency divider circuit 1119, an interface circuit 1120, a data converter 1121, and a frame memory 1122 correspond to the optical disk 1801, the optical pickup 1802, the laser diode 1803, the front monitor 1804, the reflected light receiver 1805, the actuator 1806, the stepping motor 1807, the motor driver 1808, the servo circuit 1809, the spindle motor 1810, the RF amplifier 1811, the system controller 1815, the laser driver 1816, the laser power control circuit 1817, the rotation detector 1818, the PLL and frequency divider circuit 1819, the interface circuit 1812, the data converter 1813, and the frame memory 1814 of FIG. 22, respectively. The optical disk recording device of FIG. 10 further includes a reflected light level detector 1112, a memory 1113, and an optimum image formation laser power determiner 1114.

FIG. 11 is a flowchart of an image forming method according to the present disclosure. According to the present disclosure, before performing a conventional image formation step S20, an optimum laser power adjustment process is performed which includes a test image formation step S11, a test image formed region reproduction step S12, and an optimum image formation laser power determination step S13, to form an image ensuring a maximum contrast ratio using a laser power for image formation corresponding to the number of overlaps.

The test image formation step S11, the test image formed region reproduction step S12, and the optimum image formation laser power determination step S13 will be described in detail hereinafter.

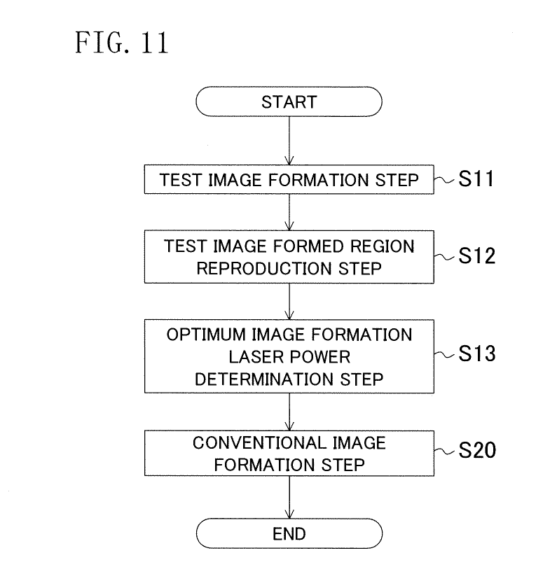

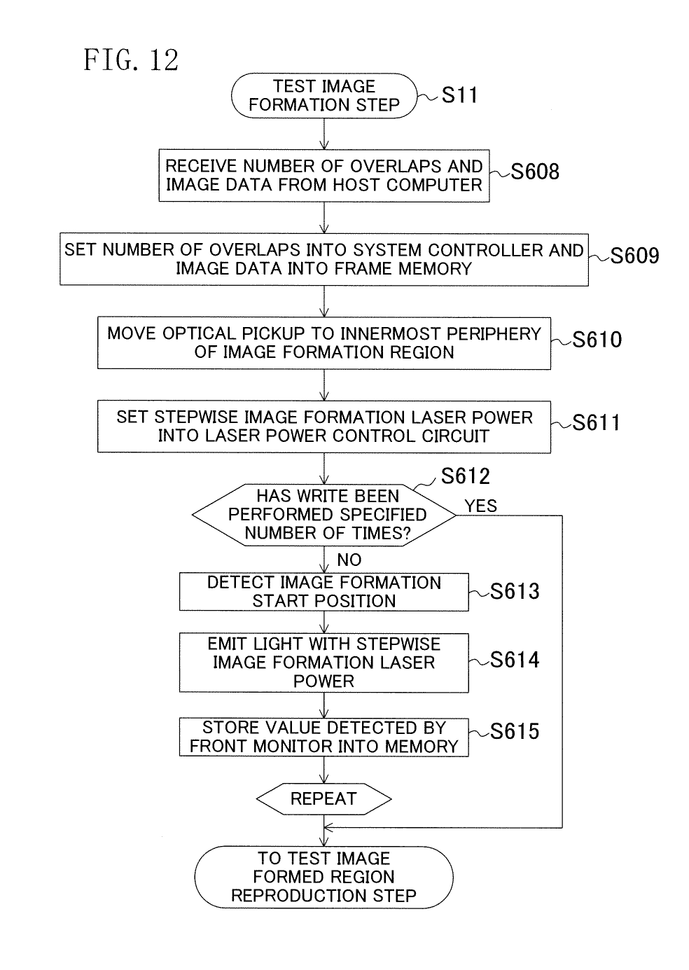

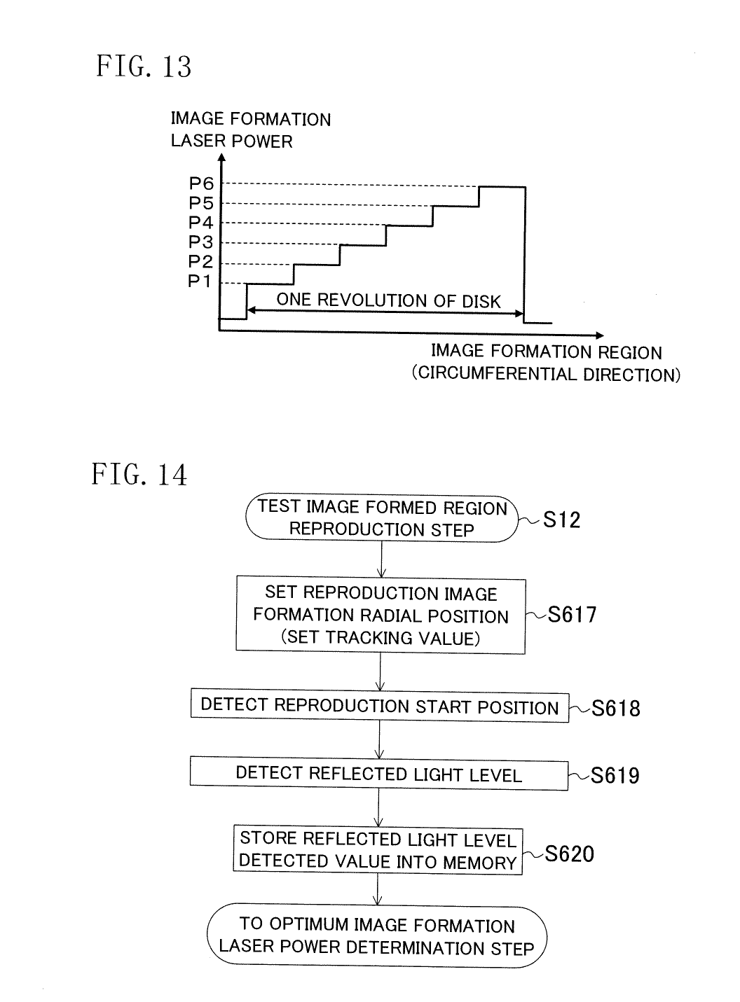

FIG. 12 is a flowchart showing details of the test image formation step S11 in the fourth embodiment of the present disclosure. The test image formation step S11 is to perform test image formation with the number of overlaps specified by a host computer while changing the image formation laser power in a stepwise manner FIG. 13 is a diagram for describing the stepwise image formation laser powers in the fourth embodiment of the present disclosure. The horizontal axis indicates a track corresponding to one revolution of a disk, and the vertical axis indicates the image formation laser power.

Initially, the number of overlaps and image data are received from the host computer (not shown) via the interface circuit 1120 (S608). The number of overlaps is set into the system controller 1115, and the image data is set into the frame memory 1122 (S609). Next, the system controller 1115 supplies a drive signal via the motor driver 1108 to the stepping motor 1107, to move the optical pickup 1102 to an innermost peripheral portion which is an image formation region (S610). The system controller 1115 also sets the stepwise image formation laser power for test image formation into the laser power control circuit 1117 (S611).

After the number of overlaps, the image data, and the image formation laser power are thus set, steps S613-S615 described below are repeatedly performed a number of times which is equal to the number of overlaps specified by the host computer (S612). Specifically, a position where image formation is started is detected based on a reference signal from the PLL and frequency divider circuit 1119 which is synchronous with the signal FG (S613), and light having the stepwise image formation laser power is emitted (S614). The emitted laser light is detected by the front monitor 1104 of the optical pickup 1102, and is converted into a voltage signal, which is supplied to the laser power control circuit 1117. The levels of the stepwise image formation laser power, i.e., image formation laser power detected values P1-P6, are stored into the memory 1113 (S615).

FIG. 14 is a flowchart showing details of the test image formed region reproduction step S12 in the fourth embodiment of the present disclosure. The test image formed region reproduction step S12 is to detect the level of light reflected from regions in which test image formation has been performed using the stepwise laser power.

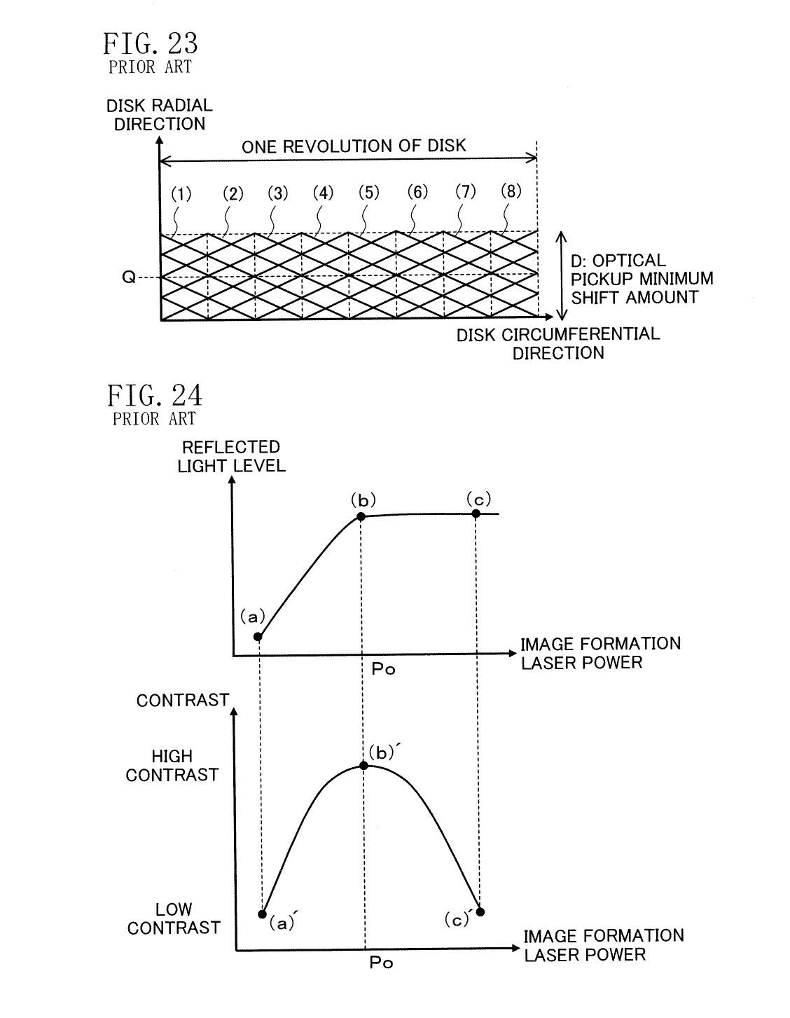

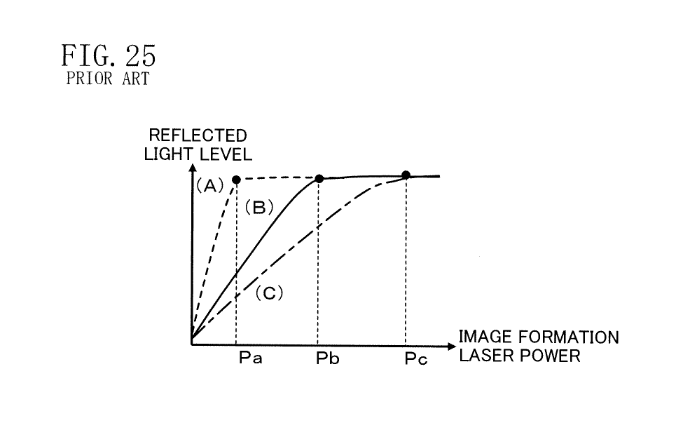

As described in the BACKGROUND section with reference to FIG. 23, an image is formed while vibrating tracking light at a predetermined frequency. A region where an image is formed stably (no irregularity) is preferable for measurement of the reflected light level. Therefore, as indicated by Q in FIG. 23, a center of the width of the formed image is reproduced. To achieve this, the system controller 1115 instructs the servo circuit 1109 to supply a tracking signal to the actuator 1106 so that the laser diode 1103 is moved to the position of the center Q (S617). Next, a position where reproduction is to be started is detected based on the reference signal from the PLL and frequency divider circuit 1119 which is synchronous with the signal FG (S618). The optical disk 1101 is irradiated with laser light having a reproduction level, and reflected light is detected by the reflected light receiver 1105 and converted into a voltage, which is supplied via the RF amplifier 1111 to the reflected light level detector 1112, so that the level of the reflected light is detected (S619). Reflected light level detected values RF1-RF6 thus detected in the regions where test image formation has been performed using the stepwise image formation laser powers P1-P6, are stored into the memory 1113 (S620).

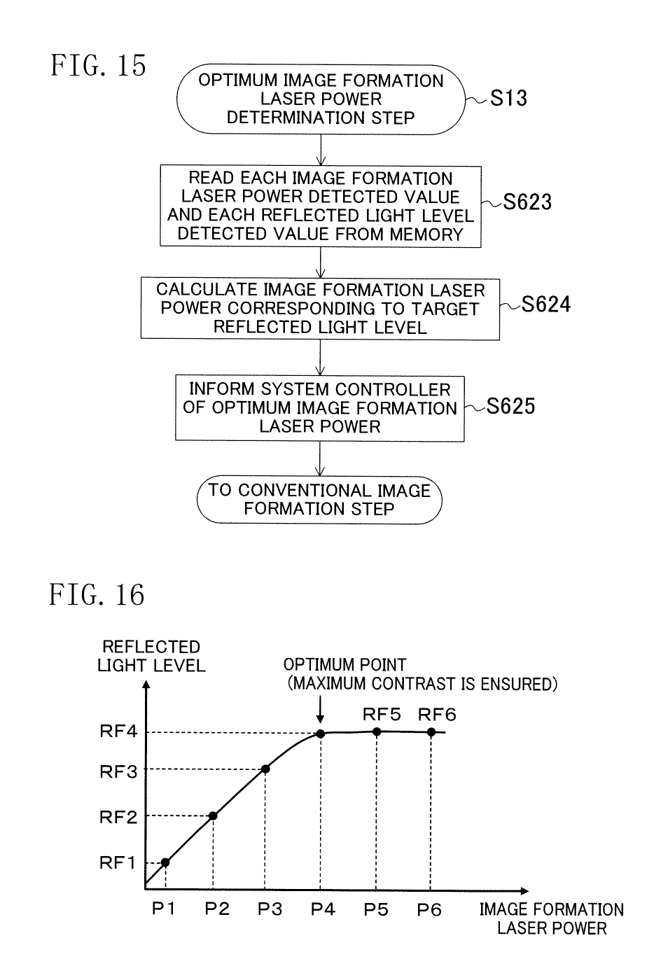

FIG. 15 is a flowchart showing details of the optimum image formation laser power determination step S13 in the fourth embodiment of the present disclosure. The optimum image formation laser power determination step S13 is to determine an optimum image formation laser power based on the image formation laser power detected values P1-P6 detected in the test image formation step S11 and the reflected light level detected values RF1-RF6 detected in the test image formed region reproduction step S12. FIG. 16 is a diagram showing the relationship between the image formation laser power and the reflected light level of an optical disk, which is used to determine the optimum image formation laser power in the fourth embodiment of the present disclosure, where the amount of reflected light increases due to a color change caused by the laser power.

Initially, the image formation laser power detected values P1-P6 and the reflected light level detected values RF1-RF6 are read from the memory 1113 (S623), and are supplied to the optimum image formation laser power determiner 1114. Next, the optimum image formation laser power determiner 1114 plots the image formation laser power detected values P1-P6 and the reflected light level detected values RF1-RF6 thus read out and performs approximation as shown in FIG. 16, and calculates an image formation laser power (P4 in FIG. 16) at a point where the approximation curve is saturated, by differentiation etc. (S624). Thereafter, the optimum image formation laser power determiner 1114 informs the system controller 1115 of the calculated image formation laser power as an optimum image formation laser power (S625). Thereafter, the system controller 1115 performs a normal image formation process using the optimum image formation laser power.

As described above, according to the information recording/reproduction device and image forming method of the fourth embodiment, the image formation laser power is optimized, depending on the number of overlaps specified by a host computer, before an image is formed, whereby the degradation of the contrast ratio of a formed image depending on the number of overlaps can be reduced or prevented.

### Fifth Embodiment

In the fourth embodiment, the image formation laser power is output in a stepwise manner on equal radii of the optical disk 1101, to calculate an optimum image formation laser power corresponding to the number of overlaps. In a fifth embodiment, in order to take measures against in-disk-surface variations (sensitivity and film thickness), test image formation is performed using a fixed image formation laser power on equal radii, and different image formation laser powers are used on different radii. Also, in order to reduce a degradation in a visible image caused by the adjustment of the image formation laser power, the test image formation region is divided into an innermost peripheral portion and an outermost peripheral portion of the optical disk 1101, and a low image formation laser power is used.

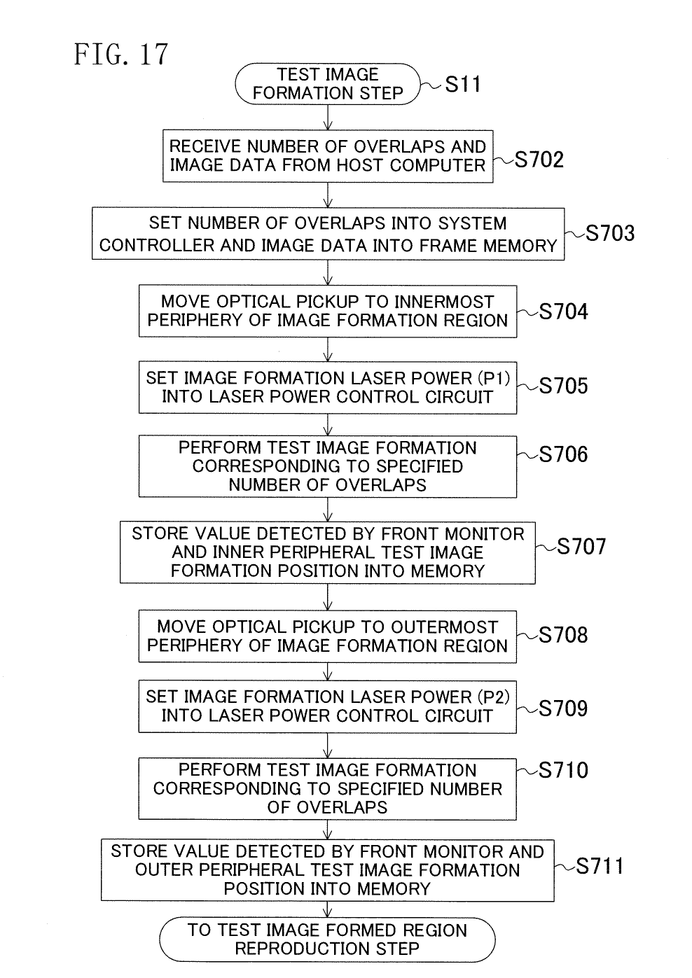

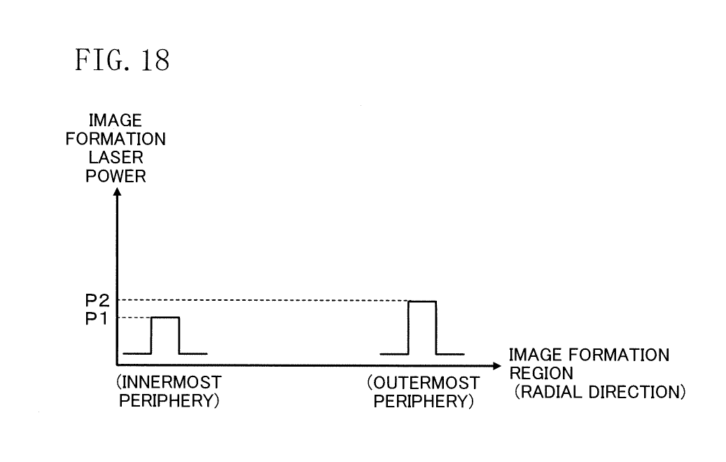

FIG. 17 is a flowchart showing details of a test image formation step S11 in an optical disk recording device which is an information recording/reproduction device according to the fifth embodiment of the present disclosure. The test image formation step S11 is to perform test image formation in the innermost peripheral portion and the outermost peripheral portion of the image formation region with the number of overlaps specified by a host computer. FIG. 18 is a diagram for describing two levels of image formation laser power in the fifth embodiment of the present disclosure.

Initially, the number of overlaps and image data are received from the host computer via the interface circuit 1120 (S702). The number of overlaps is set into the system controller 1115, and the image data is set into the frame memory 1122 (S703).

Next, the system controller 1115 supplies a drive signal via the motor driver 1108 to the stepping motor 1107, which moves the optical pickup 1102 to the innermost peripheral portion of the image formation region (S704). Thereafter, the system controller 1115 sets an image formation laser power (P1 in FIG. 18) with which test image formation is performed, into the laser power control circuit 1117 (S705). After the number of overlaps, the image data, and the image formation laser power (P1) are thus set, test image formation is performed with the specified number of overlaps (S706). Emitted laser light is detected by the front monitor 1104 of the optical pickup 1102, and is converted into a voltage signal, which is supplied to the laser power control circuit 1117 and stored as an image formation laser power detected value into the memory 1113. The radial position of the optical disk 1101 where image formation has been performed is stored into the memory 1113 (S707).

Next, the system controller 1115 supplies a drive signal via the motor driver 1108 to the stepping motor 1107, which moves the optical pickup 1102 to the outermost peripheral portion of the image formation region (S708). Thereafter, the system controller 1115 sets an image formation laser power (P2 in FIG. 18) which is different from the image formation laser power set in S705 and is used for test image formation, into the laser power control circuit 1117 (S709), and performs test image formation with the specified number of overlaps (S710). As in the process performed in the innermost peripheral portion, the image formation laser power detected value and the radial position of the optical disk 1101 where image formation has been performed are stored into the memory 1113 (S711).

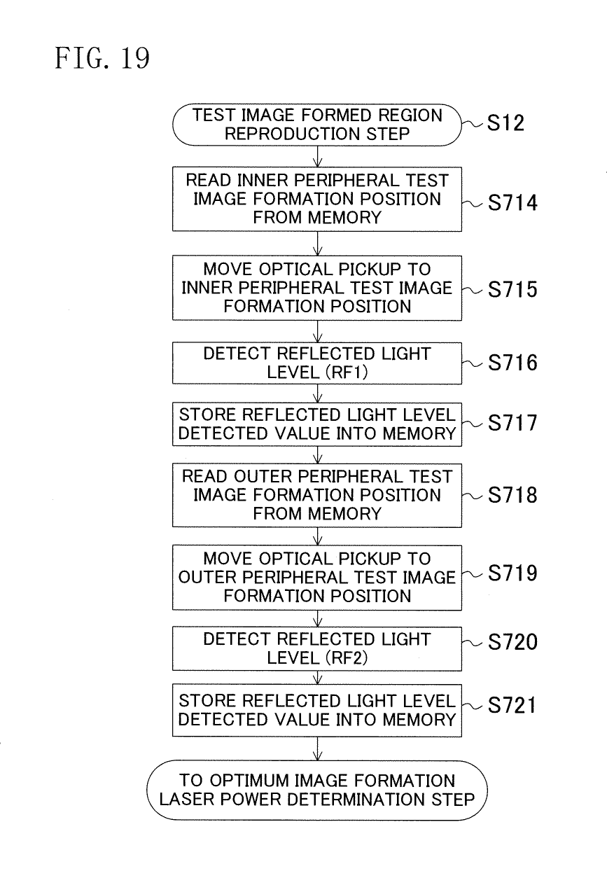

FIG. 19 is a flowchart showing details of the test image formed region reproduction step S12 in the fifth embodiment of the present disclosure. In the test image formed region reproduction step S12, the inner periphery test image formation position is read from the memory 1113 (S714), and the optical pickup 1102 is moved to the inner periphery test image formation position (S715). The optical disk 1101 is irradiated with laser light of a reproduction level at the inner periphery test image formation position. The reflected light level detector 1112 detects a reflected light level RF1 corresponding to one revolution of the optical disk 1101 (S716). An averaged value of the reflected light level RF1 is stored into the memory 1113 (S717). Similarly, an outer periphery test image formation position is read from the memory 1113 (S718), and the optical pickup 1102 is moved to the outer periphery test image formation position (S719). The optical disk 1101 is irradiated with laser light of a reproduction level at the outer periphery test image formation position. The reflected light level detector 1112 detects a reflected light level RF2 corresponding to one revolution of the optical disk 1101 (S720). An average value of the reflected light level RF2 is stored into the memory 1113 (S721).

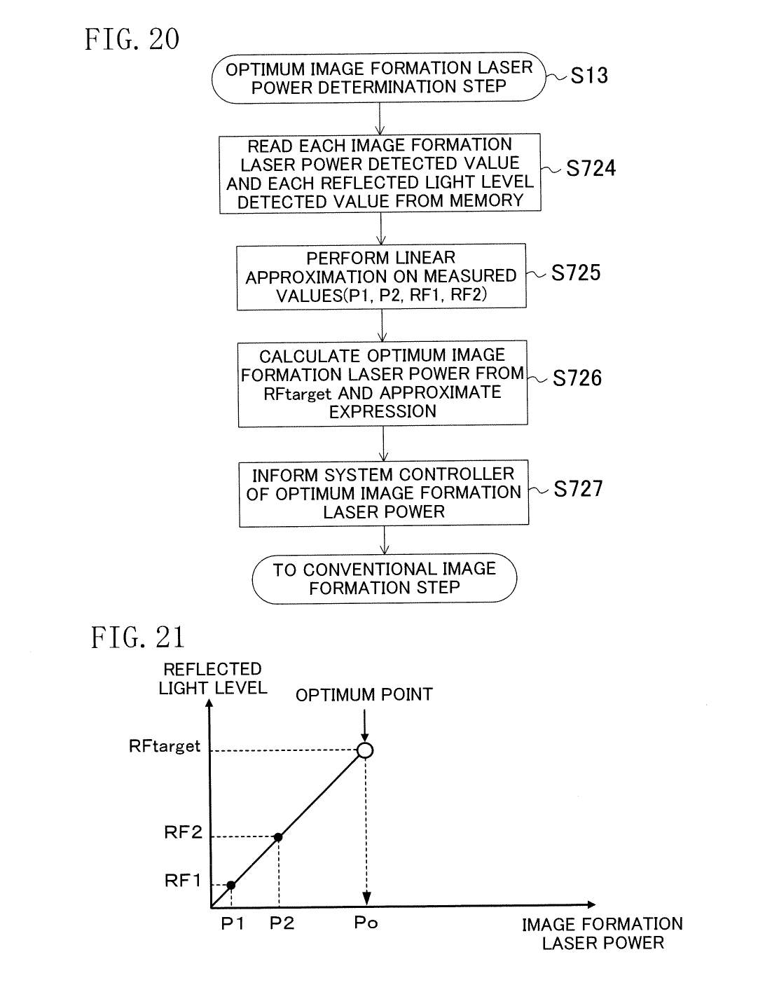

FIG. 20 is a flowchart showing details of the optimum image formation laser power determination step S13 in the fifth embodiment of the present disclosure. FIG. 21 is a diagram showing the relationship between image formation laser powers and levels of light reflected from an optical disk, which is used to determine an optimum image formation laser power in the fifth embodiment of the present disclosure.

Initially, the image formation laser power detected values P1 and P2 and the reflected light level detected values RF1 and RF2 are read from the memory 1113 (S724), and are supplied to the optimum image formation laser power determiner 1114. The optimum image formation laser power determiner 1114 plots the read-out image formation laser power detected values P1 and P2 and reflected light level detected values RF1 and RF2, and performs linear approximation as shown in FIG. 21 (S725). Thereafter, an optimum image formation laser power Po is calculated based on the linear approximate expression, and a predetermined reflected light detection target value RFtarget (S726). Thereafter, the system controller 1115 is informed of the calculated optimum image formation laser power Po (S727). Thereafter, the system controller 1115 performs a normal image formation process with the optimum image formation laser power.

As described above, according to the information recording/reproduction device and the image forming method of the fifth embodiment, test image formation is performed with the same low laser power in one revolution of an optical disk to adjust the laser power to the optimum level before image formation. In addition, the test image formation region is divided into an innermost peripheral region and an outermost peripheral region. As a result, variations in the optimum laser power adjustment and a degradation in a visual image can be reduced, and a degradation in the contrast ratio of a formed image depending on the number of overlaps can be reduced or prevented.

The integrated circuit, information recording/reproduction device, and image forming method of the present disclosure can provide an accurate shift amount, and therefore, can form a high-quality visible image, and are useful for information recording/reproduction devices which forms a visible image on the label side of a recording medium, such as optical disks etc.

The information recording/reproduction device and image forming method of the present disclosure also perform optimum image formation laser power adjustment corresponding to a specified number of overlaps before image formation, thereby reducing or preventing a degradation in the contrast ratio of a formed image depending on the number of overlaps. Therefore, the information recording/reproduction device and image forming method of the present disclosure are useful for optical disk recording devices having an image formation function as well as a typical information recording function, etc.

What is claimed is:

1. An information recording/reproduction device which includes an optical pickup including an objective lens configured to condense laser light onto an optical disk having, on the label side, an image formation surface which changes color due to heat or light, and has a function of measuring an image formation width before forming a visible image on the image formation surface using the laser light, the device comprising:
a laser emission controller configured to cause the optical pickup to emit the laser light with a predetermined power;
a movement controller configured to control the optical pickup to move, in a radial direction, a laser spot of the laser light condensed on the image formation surface;
an image formation width calculator configured to calculate the image formation width formed by the laser spot;
an image formation shift amount determiner configured to determine a shift amount for image formation based on the image formation width calculated by the image formation width calculator; and
an image formation pattern generator configured to generate an image formation pattern based on image formation data.

2. The information recording/reproduction device of claim 1, wherein
the laser emission controller controls the laser light to a laser power which allows image formation when image formation is performed, and to a laser power which does not change the color of the image formation surface when the image formation width is calculated.

3. The information recording/reproduction device of claim 1, wherein
the movement controller controls the optical pickup to move the laser spot in a direction from an inner periphery to an outer periphery when image formation is performed, and to vibrate the laser spot in the radial direction when the image formation width is calculated.

4. The information recording/reproduction device of claim 1, wherein
the image formation width calculator calculates the image formation width corresponding to a single line which changes color due to the laser spot, based on a color changed region transit time detected from an amount of returning light of the laser light when the laser spot is vibrated in the radial direction, and a speed of the laser spot.

5. An information recording/reproduction device which includes an optical pickup including an objective lens configured to condense a plurality of laser beams onto an optical disk having, on the label side, an image formation surface which changes color due to heat or light, and performs a focus control using one of the laser beams preceding in an image formation direction and forms a visible image using the other laser beam or beams, and has a function of controlling the plurality of laser beams, the device comprising:
a laser emission controller configured to control the laser beam preceding in the image formation direction to a laser power which does not change the color of the image formation surface, and the other laser beam or beams for image formation to a laser power which allows image formation;
a movement controller configured to control the optical pickup to move, in a radial direction, a laser spot formed on the image formation surface;
a focus controller configured to perform a focus control so that the laser beam preceding in the image formation direction is condensed on the image formation surface; and
an image formation pattern generator configured to generate an image formation pattern based on image formation data.

6. An information recording/reproduction device which includes an optical pickup including an objective lens configured to condense a plurality of laser beams onto an optical disk having, on the label side, an image formation surface which changes color due to heat or light, and performs a focus control using one of the laser beams preceding in an image formation direction and forms a visible image using the other laser beam or beams, and has a function of measuring an image formation width before forming the visible image on the image formation surface using the other laser beam or beams, the device comprising:
a laser emission controller configured to control the laser beam preceding in the image formation direction to a laser power which does not change the color of the image formation surface, and the other laser beam or beams for image formation to a laser power which allows image formation;
a movement controller configured to control the optical pickup to move, in a radial direction, a laser spot formed on the image formation surface;
a focus controller configured to perforin a focus control so that the laser beam preceding in the image formation direction is condensed on the image formation surface;
an image formation width calculator configured to calculate the image formation width formed by the laser spot;
an image formation shift amount determiner configured to determine a shift amount for image formation based on the image formation width calculated by the image formation width calculator; and
an image formation pattern generator configured to generate an image formation pattern based on image formation data.

7. The information recording/reproduction device of claim 6, wherein
when the image formation width is measured, the laser beam for the focus control is used to measure the image formation width.

8. In an information recording/reproduction device which includes an optical pickup including an objective lens configured to condense laser light onto an optical disk having, on the label side, an image formation surface which changes color due to heat or light, a method for measuring an image formation width by performing test write before forming a visible image on the image formation surface using the laser light, the method comprising the steps of:
controlling the laser power of the laser light for image formation to perform test write;
controlling the laser light to a laser power which does not change the color of the image formation surface, vibrating a laser spot of the laser light condensed on the image formation surface, in a radial direction across a region whose color has been changed by the test write, and detecting a color changed region based on the amount of returning light of the laser light, to measure a time required to pass through the region whose color has been changed by the test write;
calculating the image formation width based on the color changed region transit time and a speed of the laser spot at substantially a center when the laser spot is vibrated in the radial direction; and
forming a visible image on the image formation surface using laser light while adjusting a shift amount in the radial direction for image formation based on the image formation width.

9. An information recording/reproduction device comprising:
a rotation mechanism configured to rotate an optical disk having a color changing layer which changes color due to heat or light;
a laser light emitter configured to emit laser light to the color changing layer of the optical disk, and move in a radial direction of the optical disk;
a laser light emission position operator configured to operate a focus position and a radial position of the laser light emitted to the optical disk;
a reflected light detector configured to convert light reflected from the optical disk into an electrical signal, and detect a signal level of the electrical signal;
a laser emission position controller configured to, when image formation is performed on the optical disk while the optical disk is rotated through a plurality of revolutions, control the laser light emission position operator so that paths of the laser light emitted on the color changing layer of the optical disk corresponding to the respective revolutions are different from each other;
an image formation data converter configured to define gray levels of dots to be provided on circles of the optical disk, depending on image formation data to be written on the color changing layer of the optical disk; and
an optimum image formation laser power determiner configured to determine an optimum image formation laser power corresponding to the number of revolutions for which image formation is performed on the optical disk, based on the signal level detected by the reflected light receiver.

10. The information recording/reproduction device of claim 9, wherein
the optimum image formation laser power determiner determines the optimum image formation laser power by performing image formation for a predetermined number of revolutions while changing the image formation laser power in a stepwise manner on equal radii of the optical disk.

11. The information recording/reproduction device of claim 9, wherein
the optimum image formation laser power determiner determines the optimum image formation laser power by performing image formation for a predetermined number of revolutions while changing the image formation laser power in a stepwise manner, depending on any radial position of the optical disk.

12. The information recording/reproduction device of claim 9, wherein
the optimum image formation laser power determiner performs test image formation using only a low image formation laser power which changes the color of the color changing layer of the optical disk to a small extent.

13. A method for forming an image on an optical disk having a color changing layer which changes color due to heat or light, comprising the steps of:
performing test image formation with a specified number of overlaps while changing an image formation laser power;
detecting a reflected light level in each region where the test image formation has been performed; and
determining an optimum image formation laser power based on a relationship between the laser power in the test image formation and the detected reflected light level.
